(19) United States
(12) Patent Application Publication
(10) Pub. No.: US 2007/0100619 A1
(43) Pub. Date: May 3, 2007

(54) Key usage and text marking in the context of a combined predictive text and speech recognition system

(75) Inventor: Juha Purho, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/265,736

(22) Filed: Nov. 2, 2005

(51) Int. Cl. G10L 15/00

(52) U.S. Cl. 704/239

(57) ABSTRACT

A combined predictive speech and text recognition system. The present invention combines the functionality of text input programs with speech input and recognition systems. With the present invention, a user can both manually enter text and speak desired letters, words or phrases. The system receives and analyzes the provided information and provides one or more proposals for the completion of words or phrases. This process can be repeated until an adequate match is found.

### FIELD OF THE INVENTION

The present invention relates generally to predictive text input programs. More particularly, the present invention relates to the relationship between text input programs and speech recognition programs in devices such as mobile telephones.

### BACKGROUND OF THE INVENTION

In recent years, mobile telephones and other mobile electronic devices have become capable of possessing more and more features which were simply not possible only a few years ago. Many such features that are now commonly found on such mobile devices involve the ability to input text into the devices for purposes such as messaging, appointment and schedule making, and even document creation and editing. As users have become increasingly accustomed to text input capabilities on mobile devices, they have also begun to expect and demand improved text input features.

There are text input software programs for devices such as mobile electronic devices which, upon a user beginning to type a word, automatically attempts to complete the word based upon predetermined criteria. These programs are pre-populated with words such as proper names, slang, and abbreviations. Such programs often exist for a variety of languages and also are often capable of adapting in response to a user's behavior or other considerations. Such programs alleviate a user's typing burden and can be particularly helpful on small, mobile devices where the input keys tend to be quite small.

Although these programs are beneficial to users, however, they still require a significant amount of typing on the user's part. Even in more advanced systems that are capable of completing sentences, the user must still enter several words before the program can predict the remainder of the sentences. In the case of small, mobile devices, this can be cumbersome. This problem is exacerbated even more with devices where a single key can denote multiple characters. For example, on a mobile telephone, a single key can be used to enter both a single number and up to four different letters. In such a situation, users may have to input a relatively large number of characters before a program is capable of completing the word or phrase.

United States Application Publication No. 2002/069058 discloses a multimodal data input device where a user can provide a voice input of a first phonetic component of a word and a mechanical component of the word, such as a stroke or character, with which the system can attempt to determine the word that was being input. Although potentially useful, such a system is extremely limited in its usefulness, as the system requires that a user only speak a phonetic component of the word. Many individuals tend to consider such an action unnatural and cumbersome.

It would therefore be desirable to provide a system and method that enables a user to create materials such as messages, notes, and other text items in a simpler and more efficient manner on devices such as mobile electronic devices.

### SUMMARY OF THE INVENTION

The present invention provides a system and method for combining the functionality of text input programs with speech input and recognition systems. According to the present invention, a user can both manually enter text and speak desired words or phrases. The system of the present invention receives and analyzes the provided information, and then provides one or more proposal for the completion of words or phrases. This process can then be repeated until an adequate match is found.

With the present invention, users are capable of creating documents in an easier and more efficient manner than in conventional systems. In particular, with the present invention, users do not have to type as many character words as is currently necessary. This is particularly beneficial in mobile devices such as mobile telephones, where the number and size of input keys and buttons is often limited.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is a diagram showing various hardware and/or software components that are used in conjunction with various embodiments of the present invention; and

FIG. 4 is a flow chart showing the implementation of various embodiments of the present invention.

### DETAILED DESCRIPTION OF THE PREFERRED EMBODIMENTS

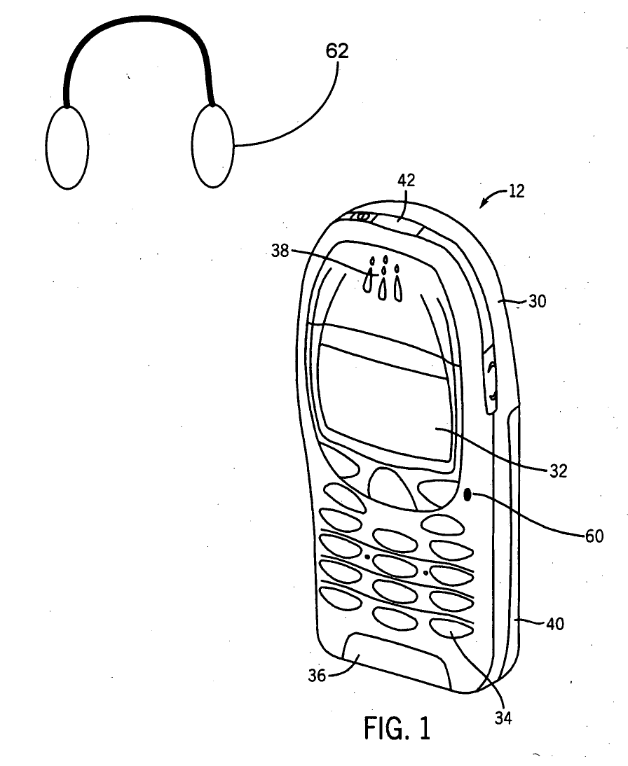

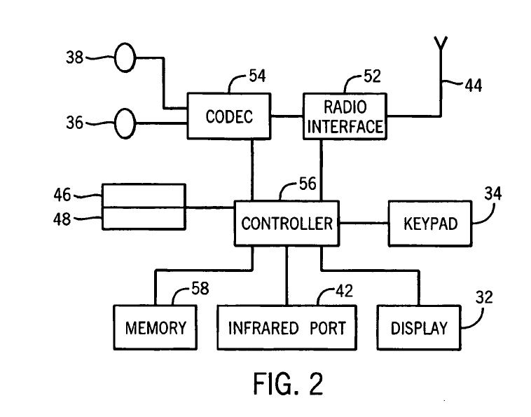

FIGS. 1 and 2 show one representative mobile telephone 12 within which the present invention may be implemented. It should be understood, however, that the present invention is not intended to be limited to one particular type of mobile telephone 12 or other electronic device. Instead, the present invention can be incorporated into devices such as laptop and desktop computers, personal digital assistants, integrated messaging devices, as well as other devices.

The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. The mobile telephone, in one embodiment of the invention, includes a voice key 60 for enabling voice input capabilities. The voice key 60 or a similar key can also be located on a related accessory, such as a headset 62 for the mobile telephone 12. Individual circuits and elements are all of a type well known in the art, for example in the Nokia range of mobile telephones.

The voice key 60 can be used in a variety of ways. In one embodiment of the invention, the voice key 60 is pressed or otherwise actuated to initiate speech input. The same key is pressed or otherwise actuated a second time to end speech input. In another embodiment, the voice key 60 is pressed and held throughout the duration of the speech input. In yet another embodiment, if the user keeps the voice key 60 pressed while also inputting text from a keypad simultaneously, the voice system can produce the sound for the actual word or phrase when the voice key is released or pressed a second time. An electronic dictionary may be used to obtain the correct pronunciation. The phonetic text may also be produced.

The present invention provides an improved combined predictive text and speech recognition system that can be used on a wide variety of electronic devices. According to the present invention, a user can speak a word into the device, as well as add a portion of a word or a series of words. A predictive engine then provides a proposal for the word or a phrase that is to be input. In the event that the proposed word or phrase does not match what was intended by the user, the user can input more information, and the process can be repeated until the correct word or phrase is proposed.

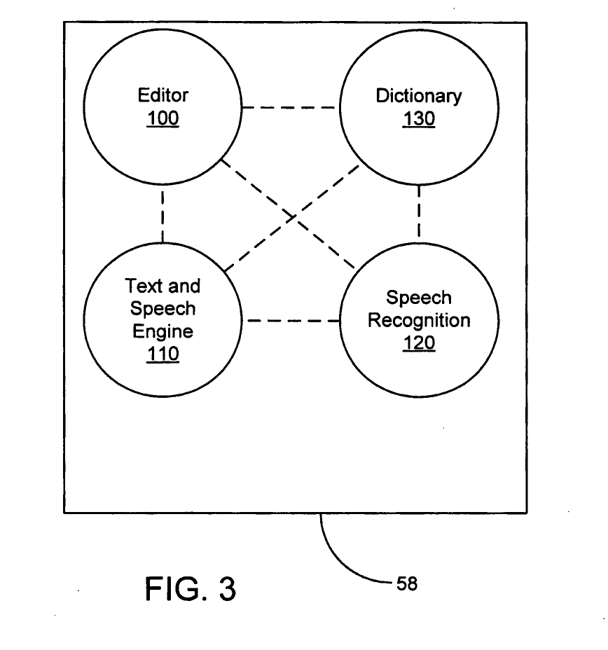

FIG. 3 is a representation of the software and/or hardware that is involved in the implementation of various embodiments of the present invention. These components include an editor 100, a predictive text and speech engine 110, and speech recognition hardware and/or software 120. The editor 100 is a software tool for text input. The editor 100 also accepts spoken input after it has been interpreted by the speech recognition hardware and/or software 120. The system can also include a dictionary or database 130 of words or phrases that can be used by the predictive text and speech engine 110. It should be noted that many or all of these components can be combined into single entities as necessary or desired. All of these items, when in software form, can be stored in the memory 58 or inside other components known in the art.

The predictive text and speech engine 110 can comprise hardware, software or a combination of both hardware and software. The predictive text and speech engine 110 takes the text and speech input and uses this information, as well as potentially other information, to produce a list of alternative interpretations of the input information. The other information that can be used by the predictive text and speech engine 110 can include, but is not limited to, a reference database of words or phrases that can be used to help in the production of a list of alternative interpretations. When a number of different proposed interpretations are provided, the user may toggle among the different interpretations to find the correct interpretation.

The predictive text and speech engine 110 may match its results to a dictionary of words, or it may use grammatical rules in its inferences. Additionally, the predictive text and speech engine 110 may alternatively base its output purely upon the text input and the spoken input. For example, the predictive text and speech engine 110 can automatically limit its candidates to only those words or phrases that contain the same characters and in the same order as those characters from the text input. The predictive text and speech engine 110 can use this subset of information to more accurately decipher the word or phrase which was apparently being spoken by the user.

In the case of text input, many devices, and mobile telephones in particular, require that individual keys each denote multiple letters. For example, the “5” key on a telephone often is used to input the letters “j”, “k” and “l”. In such a situation, the predictive text and speech engine 110, in one embodiment of the invention, infers the resulting text based upon the text input, the speech input, and other available sources as discussed herein.

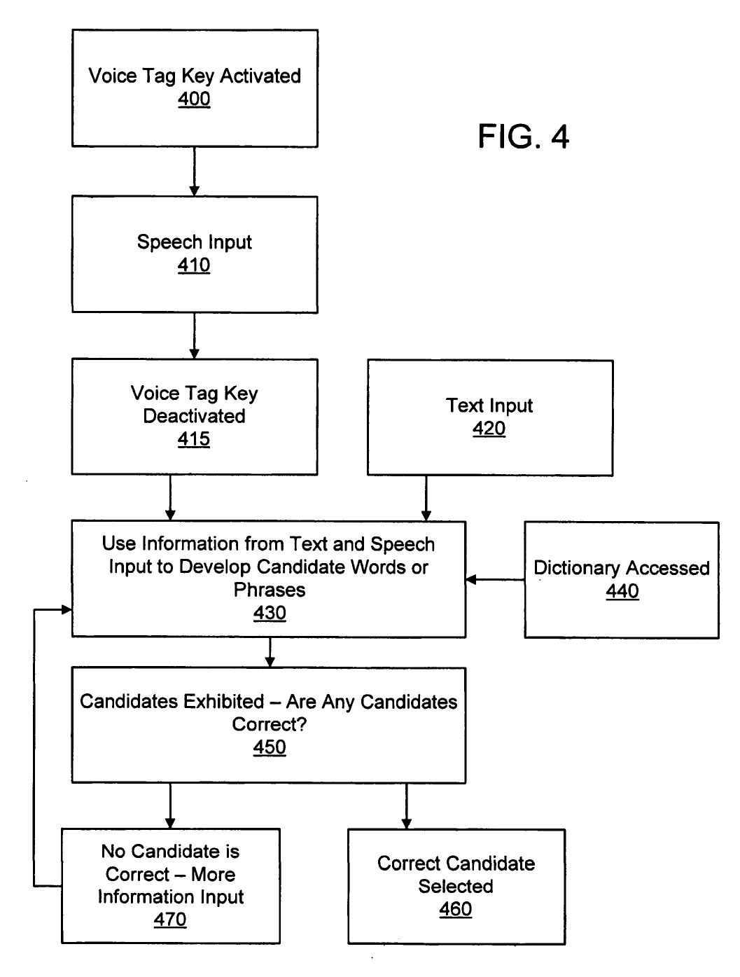

FIG. 4 is a flow chart showing the implementation of various embodiments of the present invention. At step 400, a user activates the voice key 60, enabling the system to receive voice input. At step 410, the user speaks one or more words into the device. At step 415, the voice key 60 is deactivated, indicating that the user has entered all of the speech input that is desired. The speech input is processed by the speech recognition hardware and/or software 120, as well as the editor 100, for subsequent use by the predictive text and speech engine 110. At the same time as the word(s) are being spoken, or shortly thereafter or before, the user manually inputs text into the device using keys or buttons on the device at step 420. Alternatively, the user can highlight or otherwise mark text already in the system for use by the predictive text and speech engine 110. The text information is processed by the editor 100 for subsequent use by the predictive text and speech engine 110. At step 430, the predictive text and speech engine 110 uses the processed information from the text and speech input to produce one or more candidate character strings, usually in the form of words or phrases, that match the input information and are determined to be most likely to match the word or phrase intended by the user. The predictive text and speech engine 110 can also use the associated dictionary or database 130 for determining candidate character strings. The accessing of the dictionary or database 130 is represented at step 440.

At step 450, the one or more candidate character strings are exhibited to the user. In one particular embodiment of the invention, the character strings can be ranked and identified in order of their respective probabilities of being correct. In a simple example, the most likely character string can be located at the top of the list. In more complex examples, the system can exhibit the character strings in different colors or fonts. More particularly, the most likely strings could be depicted in bold, italics, in a certain color, etc., while less likely strings could be depicted differently.

At step 460, if one of the candidate character strings matches the character string which was intended by the user, then the user selects the correct character string, which is then formally entered into the document by the system. The selecting of a character string can be accomplished using a variety of conventionally-known mechanisms, such as the input keys on the device, a stylus against a touch-sensitive display, or other mechanisms. On the other hand, if none of the candidate character strings matches what was intended by the user, then the user inputs more information at step 470. The input of additional information can be via manual input or by additional speech. The system then returns to step 430 for additional processing.

In various embodiments of the invention, the additional input of step 470 can comprise a variety of forms. For example, the user could simply type in additional letters of the word or phrase, or could alternatively shorten the word in certain situations (such as to eliminate trailing characters that the user believes may be accidentally misspelled). In another example, the user may be capable of identifying whether a word is a noun, a verb, an adjective, etc. If the system is capable of processing multiple languages, then the user may also be capable of identifying the intended language of the word.

The following are a number of different particular use scenarios for the system and process of the present invention. In a first scenario, a cursor is at the beginning of a document or is separated by a space or other separator from the previous and following words. In this situation, the user starts the voice input, says a new word or phrase that is to be input into the document, and then stops the voice input. The predictive text and speech engine 110 processes this information and then exhibits the most probable candidate or candidates.

In a second scenario, the user marks text that is to be used in conjunction with the speech input. The text can be “marked” in a variety of ways. For example, a user could highlight the particular text, underline the text, surround the text with certain markers that can be manually input, or by designating the text by using a speech code. Other marking methods known in the art may also be used. After the text is marked, the user starts the voice input, says a word or phrase that is to be input into the document, and then stops the voice input. The predictive text and speech engine 110 processes both the marked text and the input speech, determines the most probable candidate words or phrases, and then exhibits the candidate(s).

In a third use scenario, the cursor is at the beginning, middle or at the end of a word, and the word is not marked in any way. The user then starts the voice input, says a word or phrase that is to be input into the document, and then stops the voice input. In this case, the predictive text and speech engine 110 may choose to use the surrounding text as additional information to complement the words that were spoken. The text produced from the spoken info is added to the information generated via the speech recognition hardware and/or software 120. The predictive text and speech engine 110 processes the information, determines the most probable candidate words or phrases, and then exhibits the candidate(s).

In a fourth use scenario, the cursor is located within a word being typed in, and the word is marked in some form. After the text is marked, the user starts the voice input, says a word or phrase that is to be input into the document, and then stops the voice input. The speech input is then combined with the previous text input to produce the complete word (or the most likely candidates for the complete word). Alternatively, the word text information alone can be used by the predictive text and speech engine 110 to produce the most probable result.

In a fifth use scenario, the user starts the voice input, says an individual letter of the alphabet, a number, or the name of a punctuation mark or symbol, and then stops the voice input. After being processed by the speech recognition hardware and/or software 120, the predictive text and speech engine 110 is capable of recognizing the spoken input. In this case, for example, the predictive text and speech engine 110 recognizes the individual alphabet/number/punctuation/symbol that was spoken. The predictive text and speech engine 110 does not try to combine this information with the whole word being typed, instead simply adding the letter/number/punctuation/symbol to the space marked by the cursor. If there is more than one candidate letter/number/punctuation/symbol, the system displays the different candidates for selection by the user.

In one particular embodiment of the invention, a single key, such as the “star” or “*” key on a telephone, can be used to implement various features of the invention. For example, this key can be used for toggling the various alternatives produced by the predictive text and speech engine 110 (both based upon pure speech recognition and a combination of speech recognition and text input.) The “*” key or some other key also may be used for toggling to a marked portion of text or to individual letter(s) in a word. Still further, such a key may be used for toggling between a letter/number/punctuation/symbol and the spelled-out interpretation of the same item.

In another embodiment of the present invention, when the voice key 60 is activated, an indication can be shown on the display 32. For example, such an indication may comprise a particular icon or picture that appears on the display 32. Alternatively, the selected text may be highlighted with a different color, background color, font or another mechanism for identifying the text for which the present invention is being implemented apart from the rest of the text in the document. Similar “highlighting” features can include underlining the text or placing the text in bold or italics. Still further, if no text is selected by the user, the character string that is being processed may be highlighted using one of these mechanisms when the voice key is activated. Such information would indicate (1) that voice input is being accepted and (2) the precise text/character string for which the voice input would be accepted as additional information.

In yet another embodiment of the invention, a user can provide additional voice input regarding the “best guess” of the system. For example, a user can say “yes” to indicate that the best guess was correct, “next” in order to ask the system to provide the next most likely candidate as an option, or the user may decide to stop toggling through candidate words or strings by saying “stop.”

In still another embodiment of the present invention, the user may speak the name of a character or symbol which is to be inserted to the text as a single character/symbol. For example, if the user wants the character “>” to be inserted, he or she could say “greater than.” The user could also say “exclamation mark” if a “!” is to be inserted, or “dollar sign” for “$.” The same process can be used for a wide variety of other symbols as well. Similarly, the user can say a number and have the numerical value entered into the document (i.e., a user could say “one hundred twenty-three” and have “123” entered.)

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of using text and speech information to predict a character string that is desired to be entered into an electronic device, comprising:
receiving a voice input from a user;
receiving designated text input from the user;
using a predictive model to generate at least one candidate character string based upon the voice input and the designated text input; and
exhibiting the at least one candidate character string to the user.

2. The method of claim 1, further comprising:
permitting the user to select a desired candidate character string from the at least one candidate character string; and
if the user is not satisfied with any of the at least one character string:
permitting the user to provide additional input,
using the predictive model to regenerate the at least one candidate character string based in part upon the additional input, and
exhibiting the regenerated at least one candidate character string to the user.

3. The method of claim 1, wherein an associated database of character strings is accessed to aid in the generation of the at least one candidate character string.

4. The method of claim 3, wherein the database comprises a dictionary.

5. The method of claim 1, further comprising:
before receiving the voice input, receiving an indication of the activation of a voice key; and
after receiving the voice input, receiving an indication of the deactivation of a voice key.

6. The method of claim 5, wherein the designated text input is highlighted by color, font, underlining or placing predetermined characters around the text when the voice key is activated to indicate an expected voice input from the user, and wherein the highlighting ends when the voice key is deactivated.

7. The method of claim 1, further comprising enabling the user to toggle among the exhibited at least one character string using a single key.

8. The method of claim 1, wherein the designated text input is designated by marking text appearing on a display.

9. The method of claim 8, wherein the text is marked by a process selected from the group consisting of underlining, highlighting, changing font, and placing predetermined characters around the text to be designated.

10. The method of claim 1, wherein the designated text input is designated by a process selected from the group consisting of examining text appearing before a cursor appearing on a display, examining text appearing after a cursor appearing on a display, and examining text appearing both before and after a cursor appearing on a display.

11. The method of claim 1, wherein each of the at least one character string comprises a word.

12. The method of claim 1, wherein each of the at least one character string comprises a phrase.

13. The method of claim 1, wherein each character of the at least one character string is selected from the group consisting of a number, a letter, a symbol, and a punctuation mark.

14. The method of claim 1, further comprising enabling the user to manipulate the at least one character string via voice input.

15. The method of claim 1, wherein the voice input includes the name of a character selected from the group consisting of a symbol and a number, and wherein the predictive model uses the actual character in generating the at least one candidate character string.

16. A computer program product for using text and speech information to predict a character string that is desired to be entered into an electronic device, comprising:
computer code for receiving a voice input from a user;
computer code for receiving designated text input from the user;
computer code for using a predictive model to generate at least one candidate character string based upon the voice input and the designated text input; and
computer code for exhibiting the at least one candidate character string to the user.

17. The computer program product of claim 16, further comprising:
computer code for permitting the user to select a desired candidate character string from the at least one candidate character string; and
computer code for, if the user is not satisfied with any of the at least one character string:
permitting the user to provide additional input,
using the predictive model to regenerate the at least one candidate character string based in part upon the additional input, and
exhibiting the regenerated at least one candidate character string to the user.

18. The computer program product of claim 16, wherein an associated database of character strings is accessed to aid in the generation of the at least one candidate character string.

19. The computer program product of claim 16, further comprising:
computer code for before receiving the voice input, receiving an indication of the activation of a voice key; and
computer code for after receiving the voice input, receiving an indication of the deactivation of a voice key.

20. The computer program product of claim 16, wherein the designated text input is designated by marking text appearing on a display.

21. The computer program product of claim 16, wherein the designated text input is designated by a process selected from the group consisting of examining text appearing before a cursor appearing on a display, examining text appearing after a cursor appearing on a display, and examining text appearing both before and after a cursor appearing on a display.

22. An electronic device, comprising:
a processor; and
a memory unit operatively connected to the processor and including:
computer code for receiving a voice input from a user;
computer code for receiving designated text input from the user;
computer code for using a predictive model to generate at least one candidate character string based upon the voice input and the designated text input; and
computer code for exhibiting the at least one candidate character string to the user.

23. The electronic device of claim 22, wherein the memory unit further comprises:
computer code for permitting the user to select a desired candidate character string from the at least one candidate character string; and
computer code for, if the user is not satisfied with any of the at least one character string:
permitting the user to provide additional input,
using the predictive model to regenerate the at least one candidate character string based in part upon the additional input, and
exhibiting the regenerated at least one candidate character string to the user.

24. The electronic device of claim 22, wherein an associated database of character strings is accessed to aid in the generation of the at least one candidate character string.

25. The electronic device of claim 22, wherein the memory unit further comprises:
computer code for before receiving the voice input, receiving an indication of the activation of a voice key; and
computer code for after receiving the voice input, receiving an indication of the deactivation of a voice key.

26. The electronic device of claim 22, wherein the designated text input is designated by marking text appearing on a display.

27. The electronic device of claim 22, wherein the designated text input is designated by a process selected from the group consisting of examining text appearing before a cursor appearing on a display, examining text appearing after a cursor appearing on a display, and examining text appearing both before and after a cursor appearing on a display.

28. An electronic device, comprising
a processor;
a display operatively connected to the processor; and
a memory unit operatively connected to the processor and including:
a speech recognition unit for accepting a voice input from a user;
a predictive text and speech engine in operative communication with the speech recognition unit, the predictive text and speech engine configured to generate at least one candidate character string based upon the voice input and designated text input for exhibition to the user on the display.
